(19) United States
(12) Patent Application Publication
(10) Pub. No.: US 2018/0285539 A1
(43) Pub. Date: Oct. 4, 2018

(54) MULTIFACTOR STRONG AUTHENTICATION

(71) Applicant: CA, Inc., New York, NY (US)

(72) Inventors: Gaurav Agarwal, Bangalore (IN); Alok Gupta, Bangalore (IN); Siddhartha Ghosh, Bangalore (IN); Rahul Gurudas Dhavalikar, Bangalore (IN)

(21) Appl. No.: 15/472,249

(22) Filed: Mar. 28, 2017

(51) Int. Cl. G06F 21/31; G06F 21/32; H04L 29/06; G06F 21/46; H04L 9/32

(52) U.S. Cl. CPC G06F 21/316; G06F 21/32; H04L 9/3242; H04L 63/0861; G06F 21/46; H04L 63/0838

(57) ABSTRACT

Techniques are disclosed relating to multi-factor authentication of a user. In one embodiment, a computing device presents a one-time password to a user that has a sequence of characters. In response to presenting the one-time password, in various embodiments, the computing device receives a first sequence of fingers supplied by the user to a fingerprint sensor of the computing device. In some embodiments, the computing device converts the one-time password to a second sequence of fingers based on a mapping that associates fingers with characters. In one embodiment, the computer system authenticates the user by comparing the first sequence of fingers with the second sequence of fingers. In various embodiments, these actions may be performed in the context of a client-server interaction.

### BACKGROUND

### Technical Field

This disclosure relates generally to computer security, and, more specifically, to multi-factor authentication.

### Description of the Related Art

When a user typically wishes to gain access to resources protected by a computer, the user provides both a username and a password to that computer. Thereafter, the computer may look-up the user based on the username and compare the password against the know password of an authorized user in order to authenticate the user. Once a user has successfully been authenticated, the computer may present an interface to the user for accessing the requested resources. In some instances, one or more additional factors may be used when authenticating a user to guard against a single factor, such as the user's password, becoming compromised.

### SUMMARY

The present disclosure describes embodiments in which a computer system performs a multi-factor authentication based on biometric information supplied by a user. In various embodiments, a user is presented with a sequence of characters and requested to supply fingers to a fingerprint scanner in a particular ordering that is based on the characters in that sequence. The computer system may then authenticate the user by comparing a sequence of fingers supplied by a user with the presented sequence of characters. In some embodiments, the computer system uses a mapping to transform the sequence of characters into a sequence of fingers (or transform a sequence of fingers supplied by the user into one or more sequences of characters) to perform the comparison. In some embodiments, the user defines the mapping that associates fingers with characters and remembers the mapping to subsequently authenticate when presented with a given sequence of characters.

### BRIEF DESCRIPTION OF THE DRAWINGS

FIG. 1 is a block diagram illustrating an exemplary multi-factor authentication based on provided fingerprints supplied by a user, according to some embodiments.

FIG. 2A is a block diagram illustrating exemplary elements of a computing device that performs multi-factor authentication, according to some embodiments.

FIG. 2B is a block diagram illustrating exemplary elements of a system in which a client computing device interacts with a server system to perform multi-factor authentication, according to some embodiments.

FIG. 3 is a block diagram illustrating exemplary elements of a handler executable to perform multi-factor authentication, according to some embodiments.

FIGS. 4-6 are flow diagrams illustrating exemplary methods associated with multi-factor authentication.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “network interface configured to communicate over a network” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, in a one-time password that has multiple portions, the terms “first” portion and “second” portion can be used to refer to any portion of that password. In other words, the first and second portions are not limited to the initial two portions of a one-time password.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

### DETAILED DESCRIPTION

As organizations look for ways to provide additional security measures, some have turned to the use of multi-factor authentication in which two or more different factors are combined to authenticate a user. In some instances, different factors of identification may include, for example, what the user knows (a knowledge factor), what the user has (a possession factor), and/or what the user is (an inherence factor). For example, when purchasing a product, an individual may swipe a credit card (a possession factor) and provide a personal identification number (a knowledge factor). The inventors of the present disclosure recognize that multi-factor authentication often creates a less enjoyable user experience by forcing a user to provide several inputs to satisfy the different requested factors of identification. As will be described in greater detail below, the present disclosure describes embodiments in which a user may present a single type of input (e.g., a user's fingerprints in some embodiments) yet achieve the benefit of simultaneously satisfying three authentication factors: a knowledge factor, a possession factor, and an inherence factor.

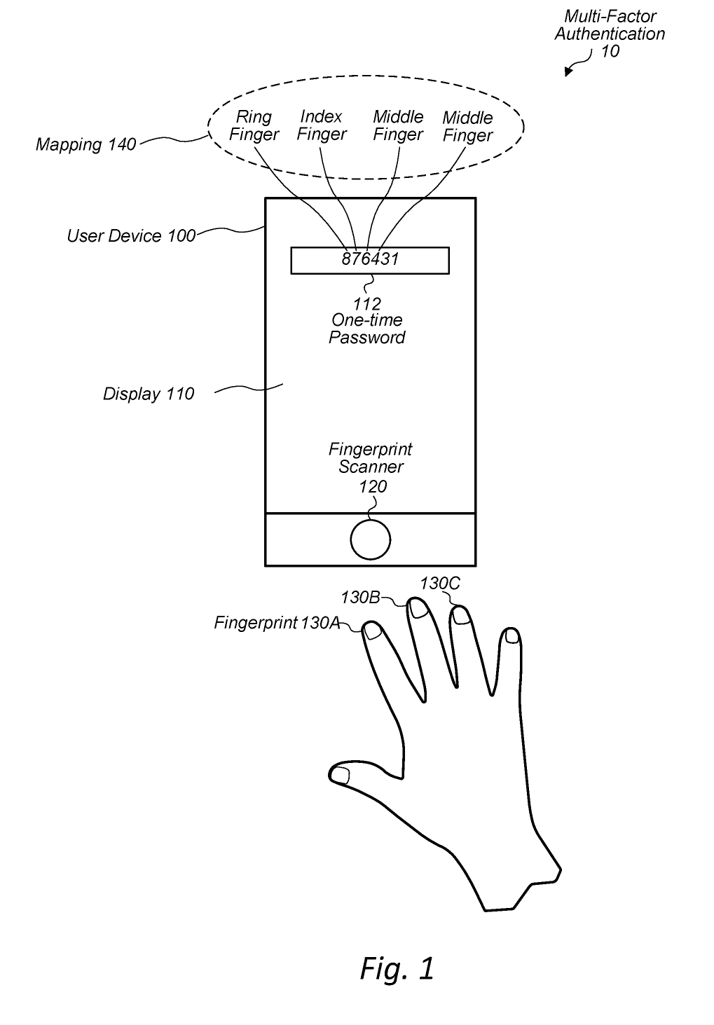

Turning now to FIG. 1, a block diagram of one embodiment of a multi-factor authentication 10 is depicted. As shown, a user device 100 may have a display 110 and a fingerprint scanner 120. In the illustrated embodiment, when a user is to be authenticated, display 110 may begin by presenting a one-time password (OTP) 112 having a sequence of characters that indicate a particular ordering in which a user is to present fingers having fingerprints 130 to fingerprint scanner 120. (As used herein, the term “one-time password” is to be interpreted in accordance with its understood meaning in the art and refers to a value that is valid for a single authentication with a computer system.) For example, as shown, display 110 may present the OTP “876431” having a mapping 140 where the character “8” may correspond to a ring finger on a person's right hand having fingerprint 130C, the character “7” may correspond to an index finger having fingerprint 130A, the character “6” may correspond to the middle finger having fingerprint 130B, and so forth. Rather than present the mapping 140 on display 110, however, authentication 10 relies on the user to be aware of the mapping 140 and know which fingerprints 130 to present based on the displayed OTP 112. Thus, a user may be authenticated based on, not only the user having matching fingerprints 130 to those of an authorized user, but also the user scanning the fingerprints 130 in the correct ordering indicated by the displayed OTP 112—i.e., fingerprints 130C, 130A, 130B, and so forth for the exemplary OTP 112 and mapping 140 depicted in FIG. 1.

In this manner, authentication 10 may confirm the three authentication factors noted above based on a single input of fingerprints 130. That is, the user being able to view the OTP 112 demonstrates a possession factor (i.e., that the user is in possession of user device 100 having display 110), the user having the correct fingerprints 130 demonstrates an inherence factor, and the user knowing mapping 140 demonstrates a knowledge factor.

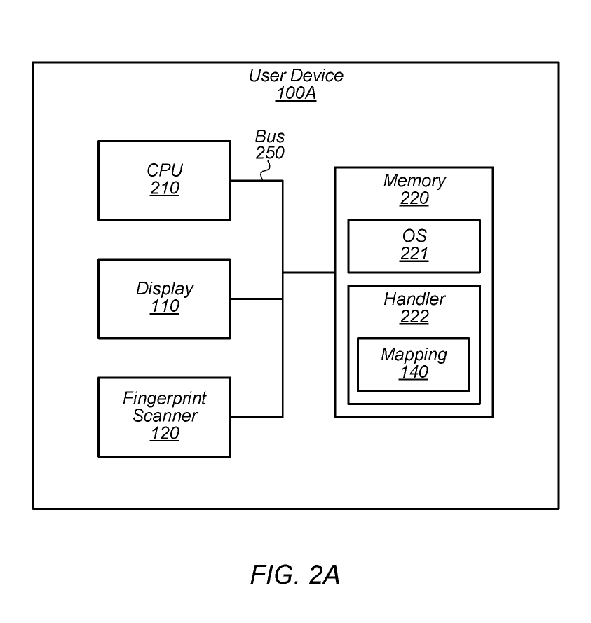

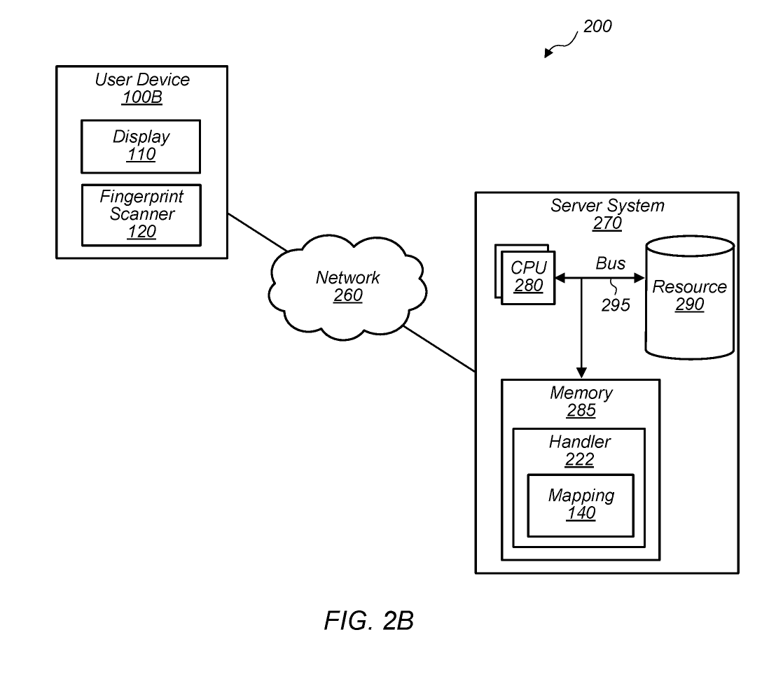

As will be described in greater detail, authentication 10 may be performed in any of various suitable contexts. In some embodiments discussed below with respect to FIG. 2A, authentication 10 may be performed by a user device attempting to verify an identity of a user in order to, for example, allow a user to log into the device or into a particular application, access confidential data on the device, enable some functionality, etc. In some embodiments discussed below with respect to FIG. 2B, authentication 10 may be performed at a server for a user interfacing with the server via a client device. This authentication 10 may be performed to access a resource provided by the server or some other computer system such as a website, database, etc.

Turning now to FIG. 2A, a block diagram of one embodiment of a user device 200A is shown. As noted above, in various embodiments, device 200A is configured to authenticate a user locally. In the illustrated embodiment, device 200A includes a CPU 210, a memory 220, a display 230, and scanner 120. As depicted, memory 220 includes an operating system (shown as OS 221) and a handler 222 that stores mapping 140. While device 200A is shown as including scanner 120, in some embodiments, scanner 120 may be located separately from device 200A (e.g., a component of another system, a standalone component, etc.).

CPU 210, in one embodiment, is a processing unit configured to execute program instructions stored in a non-transitory, computer-readable medium such as memory 220 in order to implement functionality described herein. CPU 210 may include multiple processor cores, which may each be multi-threaded. In some embodiments, CPU 210 is configured to perform techniques for improving its efficiency such as super-threading, hyper-threading, virtualization, and so on. CPU 210 may also include specialized hardware for encrypting and decrypting files using AES encryption (or any known form of encryption and decryption). In various embodiments, CPU 210 uses a cache hierarchy that includes an L1 cache and an L2 cache.

Memory 220, in one embodiment, is a non-transitory, computer-readable medium that has program instructions stored thereon that are executable by CPU 210 to cause device 200A to implement functionality described herein such as program instructions for OS 221 and handler 222. Memory 240 may be implemented using any suitable form of physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on.

Display 230, in one embodiment, is an interface configured to present content to a user such as OTP 112. In various embodiments, display 230 receives OTP 112 from handler 222 via OS 221 in response to a request to authenticate a user. Display 230, however, may receive OTP 112 from a computer system separate from device 200A. In one embodiment, as a user iteratively supplies fingerprints to scanner 120, display 230 provides an indication (e.g., bolds, highlights, etc.) of the current character of an OTP to be supplied. In this manner, a user may know which character that they are currently supplying a finger for. Display 230 may further provide an indication when a fingerprint has been received or indicate that a finger cannot be read or processed.

Fingerprint scanner 120, in one embodiment, is circuitry configured to capture information from a fingerprint 130 supplied by a user. In some embodiments, this captured information may be conveyed to another entity, such as handler 222, for further analysis. In other embodiments, scanner 120 is further configured to compare the captured information with fingerprint information of an authorized user. In instances when a match is determined, scanner 120 may indicate this result and, in some embodiments, provide a value indicative of the finger for which the match was determined. For example, scanner 120 may store a fingerprint 130 for an index finger and a fingerprint 130 for a ring finger. In response to detecting a match associated with the ring finger, scanner 120 may convey an identifier corresponding to the ring finger. As will be discussed below, handler 222 may use these identifiers to determine whether the correct fingerprint was scanned for the particular OTP 112 being displayed. On the other hand, if no match is determined, scanner 120 may indicate that it was unsuccessful. In various embodiments, scanner 120 is configured to securely store fingerprint information for an authorized user in a manner that does not permit this information to be accessed or viewed by other components or systems such as handler 222, OS 221, etc. In some embodiments, this may include scanner 120 encrypting and decrypting stored fingerprint information using, for example, RSA, Data Encryption Standard (DES), Advanced Encryption Standard (AES), etc. Although described herein as a fingerprint scanner, in some embodiments, scanner 120 may be configured to collect other forms of biometric data that can uniquely identify a user in order to perform authentication 10 such as facial recognition information, retina information, etc. Thus, while various examples are described herein with respect to fingerprints, other embodiments are contemplated in which other forms of biometric data are employed.

OS 221, in one embodiment, is an operating system that manages various aspects of device 200A. Accordingly, in some embodiments, OS 221 controls access to fingerprint scanner 120 and provides an interface (e.g., an application programming interface (API)) through which an application, such as handler 222, can request the use of fingerprint scanner 120 and receive results from scanner 120. OS 221 may also present prompts via display 110 to instruct a user when to present fingers to scanner 120 and to provide an OTP 112 provided by handler 222. In some embodiments, OS 221 also controls access to device 100A, which may include presenting a lock screen and unlocking the device in response to a successful authentication 10 as indicated by handler 222.

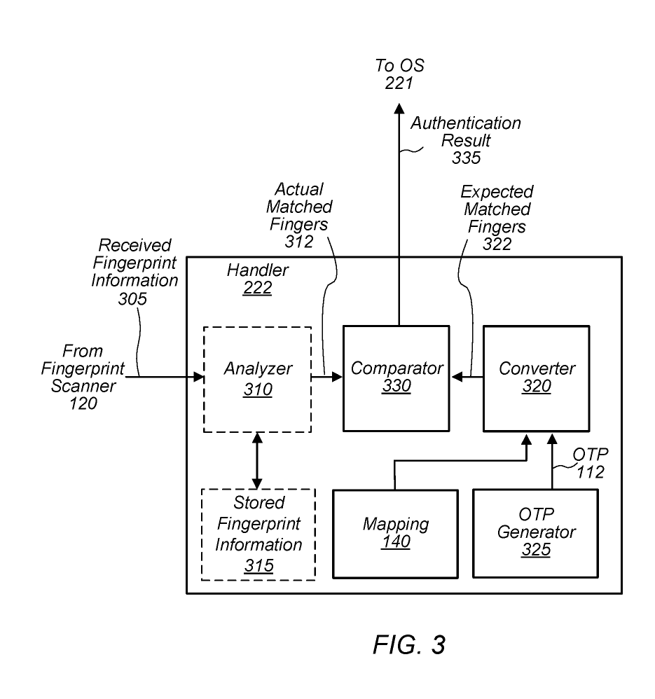

Handler 222, in one embodiment, works with fingerprint scanner 120 to facilitate the authentication 10 of a user. In various embodiments, handler 222 receives fingerprint information from scanner 120 (e.g., via an API of OS 221) and compares the sequence of fingers supplied to fingerprint scanner 120 with characters of an OTP 112. If a match is determined, handler 222 may, for example, instruct OS 221 to provide the user access to device 200A (or the resource for which authentication 10 is being performed). Accordingly, as will be described in greater detail below with respect to FIG. 3, handler 222 may generate the OTP 112 and issue a request to OS 221 to have display 110 present OTP 112 to a user. Handler 222 may also establish mapping 140 with a user and use mapping 140 to convert the OTP 112 to a value that is comparable against the fingerprint information received from fingerprint scanner 120 (or, in other embodiments, use mapping 140 to convert the fingerprint information received from scanner 120 to a value comparable with the OTP 112).

Mapping 140, as noted above, facilitates the conversion between an OTP 112 and a sequence of fingers/fingerprints 130. In various embodiments, handler 222 establishes mapping 140 during an initial registration of a user in which handler may present a prompt via display 110 and ask a user to associate particular characters to be used in OTP generation with particular fingers. Handler 222 may permit any suitable relation of characters to biometric data. For example, mapping 140 may be a one-to-one mapping such that each OTP character is mapped to a respective fingerprint 130. Mapping 140 may also associate one finger with multiple characters or one character with multiple fingers. For example, a user may define mapping 140 to associate the user's left-hand thumb finger with odd numbers and the user's right-hand thumb finger with even numbers. In various embodiments, mapping 140 includes an identifier for each finger (or stored fingerprint 130) associated with a character that may be included in an OTP. That is, in response to a successful match of a particular fingerprint 130 (e.g., 130C), scanner 120 may provide an indication of a supplied finger (e.g., an identifier for fingerprint 130C), and mapping 140 may specify an association for that indication to a particular character (or characters) that make up an OTP 112. As noted above, in various embodiments, a user may need to remember mapping 140 once established in order to correcting authenticate later.

Turning now to FIG. 2B, a block diagram of a system 200 is shown in which a server system authenticates a user attempting to gain access to resources provided by the server system. In the illustrated embodiment, system 202 includes a user device 200B and a server system 270, which both communicate over a network 260. As shown, device 200B includes display 110 and fingerprint scanner 120. Server system 270, in turn, includes a CPU 280, a memory 285 including handler 222, and a resource 290 coupled together via a bus 295.

As with discussed above with user device 200A, in one embodiment, user device 200B is configured to present an OTP 112 via display 110 and collect information about fingers supplied by a user via fingerprint scanner 120. Rather than perform authentication locally, user device 200B, in the illustrated embodiment, communicates collected information over network 260 to server system 270, which may perform authentication via handler 222. User device 200B may correspond to any suitable computing device.

Network 260 may be any suitable form of computer network, which allows user device 200B and server system 270 to exchange data. Accordingly, network 260 may include a combination of wired and wireless technologies that include optical fiber, Ethernet, cellular, radio, and the like. Network 260 may be implemented through bridges, repeaters, switches, routers, modems, and firewalls. Network 260 may be a local area network, wide area network, enterprise private network, virtual private network, and so on.

Server system 270, in one embodiment, facilitates the authentication a user attempting to gain access to a resource 290 provided by system 270 (or a resource provided user device 200B in some embodiments). Accordingly, server system 270 may generate an OTP 112, supply the OTP 112 to user device 100B, collect fingerprint information from user device 100B, and compare the collected information against the generated OTP 112. In the illustrated embodiment, system 270 implements this functionality by executing handler 222 on CPU 280. Resource 290 may correspond to any suitable element for authentication is warranted. For example, resource 290 may be a database server, a file server, a mail server, a print server, a web server, a game server, and/or an application server implemented by system 270. In some embodiments, resource 290 may be accessible to an application executing on user device 200B. For example, a banking application executing on device 200B may retrieve an account balance stored in resource 290 in response to a successful authentication of a user. In other embodiments, resource 290 may be accessible be an application executing on server system 270. For example, a user may log into a banking website via a browser executing on user device 200B, and system 270 may present an account balance stored in resource 290 in response to a successful authentication of a user. In some embodiments, functionality provided by system 270 may be provided as part of a software as a service (SaaS). For example, in some embodiments, system 270 may deliver an application to user devices 200B that uses an authentication service provided by system 270. In some embodiments, system 270 may provide access to content, such as virtual machine executing on system 270.

Turning now to FIG. 3, a block diagram of one embodiment of handler 222 is shown. In the illustrated embodiment, handler 222 includes a mapping 140, an analyzer 310, stored fingerprint information 315, a converter 320, an OTP generator 325, and a comparator 330. In some embodiments, handler 222 may be implemented differently than shown. For example, in some embodiments, functionality associated with elements 310 and 315 may be implemented by fingerprint scanner 120 discussed above, and thus elements 310 and 315 may not be included in handler 222 as indicated by the dotted lines. While handler 222 is shown as a single block in FIG. 3, in various embodiments, portions of handler 222 may be interspersed across multiple locations; functionality described with respect to handler 222 may also be software and/or hardware distinct from handler 222.

Analyzer 310, in some embodiments, analyzes fingerprint information 305 received from scanner 120 against stored fingerprint information 315 in order to determine whether a scanned fingerprint 130 matches the fingerprint of a known/authorized user. As noted above, in other embodiments, this analysis may be handled by fingerprint scanner 120. Similar to the embodiments discussed above, analyzer 310 may indicate, to comparator 330, not only whether a match is determined but also, in the event of a match, the particular finger/fingerprint for which a match was determined shown as matched fingers 312.

OTP generator 325, in one embodiment, generates an OTP 112 to be displayed to the user and compared against received fingerprint information 305. OTP generator 325 may use any suitable algorithm for generating an OTP. Accordingly, in one embodiment, OTP generator 325 may employ a random number generator to produce OTP 112. In some embodiments, generator 325 may employ an OTP generation algorithm based on a keyed-hash function algorithm such as HMAC-based OTP (HOTP) defined in accordance with RFC 4226 or Time-based (TOTP) defined in accordance with RFC 6238. In an embodiment in which HOTP is implemented, for example, generator 325 may use a counter value and a private symmetric key as inputs into a HMAC-SHA-1 algorithm (defined in accordance with RFC 2104) that calculates and outputs a value of a specified bit length. Generator 325 may truncate the outputted value and, in the illustrated embodiment, present the truncated value to the converter 320. After generating an OTP 112, generator 325 may increment (or decrement) the counter value in order to generate a new, unique OTP in a subsequent generation request. Although FIG. 1 depicts an OTP 112 that includes merely numbers, generator 325 is not limited to merely generating numeric OTPs 112; OTPs 112 may also include letters, special characters, or a combination thereof.

Converter 320, in some embodiments, uses mapping 140 to convert an OTP 112 into a value that can be compared by comparator 330 against information provided by fingerprint scanner 120 (or analyzer 310). For example, in some embodiments, converter 320 transforms a sequence of characters of an OTP 112 presented to user into an expected sequence of matched fingers 322 based on mapping 140. In other embodiments, however, converter 320 may use mapping 140 to transform received information identifying a sequence of actual matched fingers 312 into an expected set of one or more OTPs 112 and provide the expected OTPs 112 to comparator 330 for comparison against the actual OTP 112 presented to the user.

Comparator 330, in various embodiments, determines a result 335 of authentication 10 by comparing data associated with an actual input of a user with data associated with an expected input based on the displayed OTP 112. As noted above, in some embodiments, this comparison may be between a set of actual matched fingers 312 and an expected set of matched fingers 322 as shown in FIG. 3. In some embodiments, this comparison may be between the actual OTP 112 presented on display 110 and a set of OTPs 112 obtainable from mapping 140 and the actual sequence of fingers supplied. In other embodiments, comparator 330 may compare other values associated with OTP 112 and a user's input. In the illustrated embodiment, comparator 330 provides authentication results 335 to OS 221, which may determine whether to grant access based on the result 335; however, in other embodiments, comparator 330 may provide results 335 to any other suitable entity that acts on a result 335 to determine grant access to a resource.

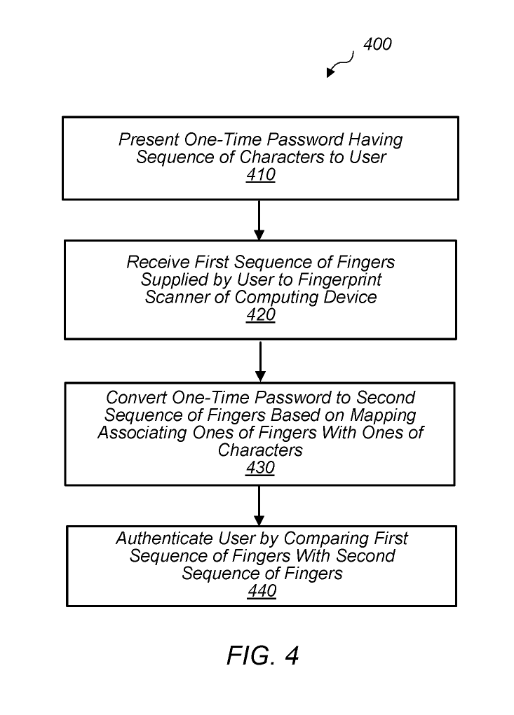

Turning now to FIG. 4, a flow diagram of a method 400 is shown. Method 400 is one embodiment of a method performed by a computing device such as device 100A or system 270 to implement multi-factor authentication of a user. In some instances, performance of method 400 provides a more secure authentication while simplifying user involvement. In some embodiments, the steps of method 600 may include additional steps—e.g., receiving additional credentials from a user, providing the user access to a requested resource, generating an OTP (e.g., OTP 112), etc.

Method 400 begins in step 410 with a computing device presenting, to a user, an OTP (e.g., OTP 112) having a sequence of characters. In some embodiments, the computing device performs an OTP derivation function to derive this OTP; however, the computing device may receive the OTP from another computing device. In one embodiment, prior to presenting the OTP to the user, the computing device instructs an authorized user to establish a mapping (e.g., mapping 140) associating fingers with characters. In some cases, this mapping may associate at least two or more characters that may appear in an OTP with the same finger. In other cases, the mapping may associate at least two or more fingers with the same character.

In step 420, the computing device receives a sequence of fingers supplied by a user to a fingerprint sensor (e.g., scanner 120) of the computing device. In various embodiments, the fingerprint sensor is configured to compare fingerprint information received from the user with fingerprint information stored (e.g., fingerprints information 315) for an authorized user. In various cases, the sequence of fingers identifies fingers that have fingerprint information determined to match the stored fingerprint information. In some embodiments, the computing device, receives the sequence of fingers via an application program interface (API) supplied by an operating system that manages the fingerprint sensor.

In step 430, the computing device converts the presented OTP into a sequence of fingers based on a mapping that associates fingers with characters. In step 440, the computing device authenticates the user by comparing the sequence of fingers received from the user with the converted sequence of fingers. In response to authenticating the user, the computing device may provide the user access to a resource such as an application executing on the computer system.

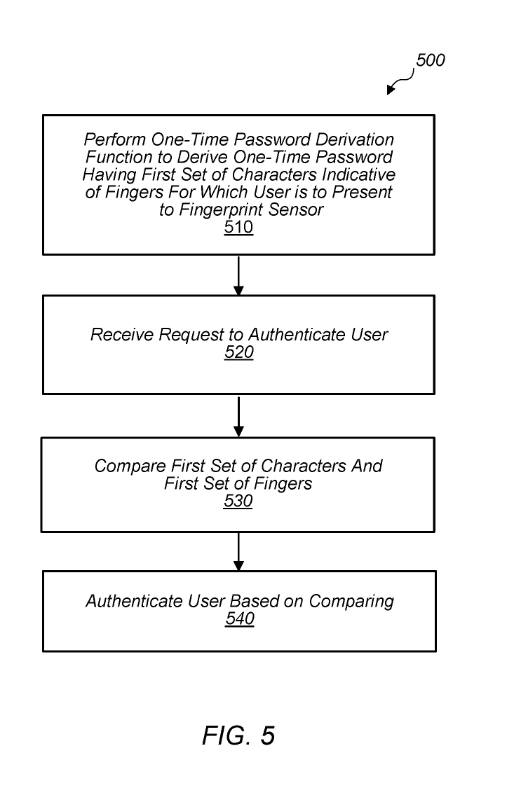

Turning now to FIG. 5, a flow diagram of a method 500 is shown. Method 500 is one embodiment of another method performed by a computer system (e.g., system 270) implementing multi-factor authentication. Similar to method 400, performance of method 400 provides a more secure authentication while simplifying user involvement. In some embodiments, the steps of method 500 include additional steps—e.g., sending an OTP to another computer system that collects fingerprint information, etc.

Method 500 begins in step 510 with a computer system performing an OTP derivation function to derive an OTP having a set of characters indicative of fingers for which a user is to present to a fingerprint sensor. In various embodiments, the computer system performs the derivation function by using a secret key to apply a keyed-hash function (e.g., HOTP or TOTP) to a counter value (or time value) to derive the OTP. In response to generating the OTP, the computer system may send the OTP to another computer system that is configured to present the OTP to a user.

In step 520, the computer system receives a request to authenticate a user. In various embodiments, the request identifies a set of fingers that a user has supplied to the fingerprint sensor. The computer system may receive this request from another computer system, which may be the one presenting the OTP to the user, in some embodiments. Prior to receiving the request, in some embodiments, the computer system prompts a user to provide a mapping that associates ones of characters with ones of the user's fingers. In various embodiments, this mapping indicates that at least one finger of the set of fingers maps to two or more characters.

In step 530, the computer system compares the set of characters of the OTP with the set of fingers supplied by a user in response to receiving the request. In various embodiments, in order to perform the comparison, the computer system applies a mapping to transform the set of characters of the OTP into a set of fingers. In such embodiments, the computer system may further determine whether the transformed set of fingers matches the user supplied set of fingers. This determination may include determining whether an ordering of the transformed set matches an ordering of the user supplied set. In some embodiments, instead of transforming characters of an OTP into indications of fingers, the computer system applies a mapping to transform the user supplied set of fingers into one or more sets of characters. Accordingly, the computer system may further determine whether the one or more sets of characters match the set of characters of the OTP. In step 540, the computer system authenticates the user based on a successful comparison.

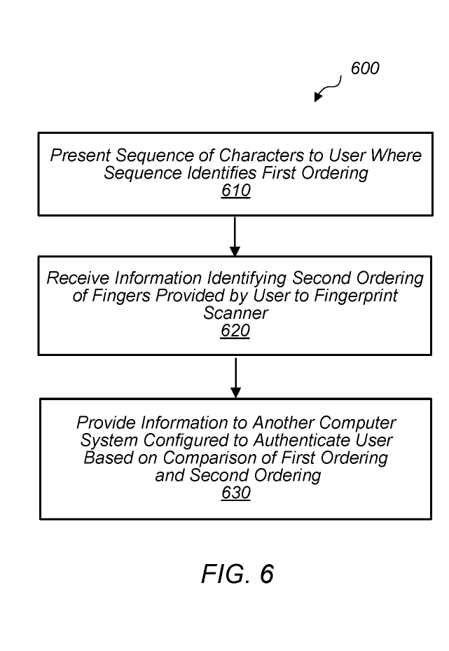

Turning now to FIG. 6, a flow diagram of a method 600 is shown. Method 600 is one embodiment of a method performed by a computer system (e.g., device 100A/B) that interacts with another computer system to perform a multi-factor authentication. In some embodiments, the steps of method 600 include additional steps—e.g., receiving a response indicating that the user has been authenticated, granting the user access to the requested resources, etc.

Method 600 begins in step 610 with a computer system presenting a sequence of characters to a user. In various embodiments, the sequence of characters identifies an ordering in which a user is to present fingers to a fingerprint scanner of the computer system. In some embodiments, each character of the sequence identifies a particular finger to be provided to the fingerprint scanner. The computer system may generate the sequence of characters or receive them from a separate computer. In various embodiments, the computer system generates the sequence of characters by performing a character sequence generation algorithm (e.g., TOTP) that uses a time value and a secret key as inputs.

In step 620, the computer system receives information that identifies an ordering of fingers provided by a user to a fingerprint scanner.

In step 630, the computer system provides the information to a separate computer system that is configured to authenticate the user based on a comparison of an ordering of the presented sequence and an ordering of fingers supplied by the user. In order to perform the comparison, the separate computer system may convert the presented sequence of characters into a sequence of fingers based on a mapping defined by an authorized user. After providing the information, in some embodiments, the computer system receives a response from the separate computer system that indicates that the user has been authenticated. In response to the user being authenticated, the computer system may grant the user access to a resource provided by the computer system or associated with the separate computer system.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory, computer-readable medium having program instructions stored thereon that are executable by a computing device to cause the computing device to perform operations comprising:
presenting, to a user, a one-time password having a sequence of characters;
in response to the presenting, receiving a first sequence of fingers supplied by the user to a fingerprint sensor of the computing device;
converting the one-time password to a second sequence of fingers based on a mapping associating ones of the fingers with ones of the characters; and
authenticating the user by comparing the first sequence of fingers with the second sequence of fingers.

2. The computer readable medium of claim 1, wherein the fingerprint sensor is configured to compare fingerprint information received from the user with fingerprint information stored for an authorized user, wherein the first sequence of fingers identifies fingers having fingerprint information determined to match the stored fingerprint information for the authorized user.

3. The computer readable medium of claim 1, wherein the first sequence of fingers are received via an application programming interface (API) supplied by an operating system that manages the fingerprint sensor.

4. The computer readable medium of claim 1, wherein the operations further comprise:
prior to the presenting, instructing an authorized user to establish the mapping associating ones of the fingers with ones of the characters.

5. The computer readable medium of claim 1, wherein the mapping associates at least two or more of the characters to the same finger.

6. The computer readable medium of claim 1, wherein the mapping associates at least two or more of the fingers to the same character.

7. The computer readable medium of claim 1, wherein the operations further comprise:
in response to authenticating the user, providing the user access to an application executing on the computing device.

8. A non-transitory, computer-readable medium having program instructions stored thereon that are executable by a first computer system to cause the first computer system to perform operations comprising:
performing a one-time password derivation function to derive a one-time password having a first set of characters indicative of fingers for which a user is to present to a fingerprint sensor;
receiving a request to authenticate a user, wherein the request identifies a first set of fingers supplied to the fingerprint sensor; and
in response to receiving the request:
comparing the first set of characters and the first set of fingers; and
authenticating the user based on the comparing.

9. The computer-readable medium of claim 8, wherein the comparing includes:
applying a mapping to transform the first set of characters into a second set of fingers; and
determining whether the first and second sets of fingers match, including determining whether an ordering of the first set of fingers matches an ordering of the second set of fingers.

10. The computer-readable medium of claim 8, wherein the comparing includes:
applying a mapping to transform the first set of fingers into one or more sets of characters; and
determining whether at least one of the one or more sets of characters matches the first set of characters.

11. The computer-readable medium of claim 10, wherein the mapping indicates that at least one of the first set of fingers maps to two or more characters.

12. The computer-readable medium of claim 8, wherein the operations further comprise:
prior to receiving the request, prompting the user to provide a mapping that associates ones of the characters with ones of the user's fingers.

13. The computer-readable medium of claim 8, wherein the operations further comprise:
sending the one-time password to a second computer system configured to present the one-time password to the user, wherein the request is received from the second computer system.

14. The computer-readable medium of claim 8, wherein the performing of the one-time password derivation function includes using a secret key to apply a keyed-hash function to a counter value to derive the one-time password.

15. A method, comprising:
a first computer system presenting a sequence of characters to a user, wherein the sequence identifies a first ordering in which the user is to present fingers to a fingerprint scanner of the first computer system, wherein each character of the sequence identifies a particular one of the fingers to be provided to the fingerprint scanner;
the first computer system receiving information identifying a second ordering of fingers provided by the user to the fingerprint scanner; and
the first computer system providing the information to a second computer system configured to authenticate the user based on a comparison of the first ordering and the second ordering.

16. The method of claim 15, wherein the comparison includes converting the sequence of characters into the first ordering based on a mapping of characters to fingers defined by an authorized user.

17. The method of claim 15, further comprising:
the first computer system receiving, from the second computer system, a response indicating that the user has been authenticated; and
based on the response, the first computer system granting the user access to a resource provided by the first computer system.

18. The method of claim 15, further comprising:
the first computer system receiving, from the second computer system, a response indicating that the user has been authenticated and granted access to a resource associated with the second computer system.

19. The method of claim 15, wherein the presenting includes receiving the sequence of characters from the second computer system.

20. The method of claim 15, wherein the presenting includes the first computer system generating the sequence of characters by using a time value and a secret key as inputs into a character sequence generation algorithm.
